(19) United States
(12) Patent Application Publication
(10) Pub. No.: US 2026/0012632 A1
(43) Pub. Date: Jan. 8, 2026

(54) Method and Apparatus for Picture Padding in Video Coding

(71) Applicant: MEDIATEK INC., Hsinchu City (TW)

(72) Inventors: Yu-Cheng LIN, Hsinchu City (TW); Tzu-Der CHUANG, Hsinchu City (TW); Chih-Wei HSU, Hsinchu City (TW); Ching-Yeh CHEN, Hsinchu City (TW)

(21) Appl. No.: 18/881,548

(22) PCT Filed: Jul. 5, 2023
(86) PCT No.: PCT/CN2023/105860

§ 371 Date: Jan. 6, 2025

Related U.S. Application Data
(60) Provisional application No. 63/369,090, filed on Jul. 22, 2022.

(51) Int. Cl. H04N 19/52; H04N 19/159; H04N 19/176; H04N 19/82

(52) U.S. Cl. CPC H04N 19/52; H04N 19/159; H04N 19/176; H04N 19/82

(57) ABSTRACT

A method and apparatus for padding out-of-boundary pixels are disclosed. According to the method, input data associated with a current block located at or near a picture boundary are received, wherein the input data comprise prediction data and reconstructed residual data related to the current block. An extended motion-compensated reconstructed block for the current block is generated based on the prediction data and the reconstructed residual data, wherein the extended motion-compensated reconstructed block for the current block is inter coded and comprises a padded area located outside the picture boundary and a reconstructed current block. At least one in-loop filter is applied to the extended motion-compensated reconstructed block.

### CROSS REFERENCE TO RELATED APPLICATIONS

The present invention is a non-Provisional Application of and claims priority to U.S. Provisional Patent Application No. 63/369,090, filed on Jul. 22, 2022. The U.S. Provisional Patent Application is hereby incorporated by reference in its entirety.

### FIELD OF THE INVENTION

The present invention relates to padding out-of-boundary pixels in video coding system. In particular, the present invention relates to an efficient way of generating the padded samples during pixel or block reconstruction stage.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments duc to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Trec Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

In HEVC, reference pictures are extended by a perpendicular padding of the picture boundary samples. During the standardization of VVC, new methods are investigated for boundary padding, which use either inter-prediction based techniques or intra-prediction based techniques. In the present invention, an efficient padding technique by padding the out-of-boundary pixels during the reconstruction stage is disclosed.

### BRIEF SUMMARY OF THE INVENTION

A method and apparatus for padding out-of-boundary pixels are disclosed. According to the method, input data associated with a current block located at or near a picture boundary are received, wherein the input data comprise prediction data and reconstructed residual data related to the current block. An extended motion-compensated reconstructed block for the current block is generated based on the prediction data and the reconstructed residual data, wherein the extended motion-compensated reconstructed block for the current block is inter coded and comprises a padded arca located outside the picture boundary and a reconstructed current block. At least one in-loop filter is applied to the extended motion-compensated reconstructed block.

In one embodiment, the current block corresponds to a 4×4 block at or near the picture boundary and the extended motion-compensated reconstructed block comprises M padded lines beyond the picture boundary, wherein M is a positive integer. In another embodiment, the current block corresponds to a W×H block at or near the picture boundary and the extended motion-compensated reconstructed block comprises M padded lines beyond a horizontal picture boundary if the current block is at or near the horizontal picture boundary or beyond a vertical picture boundary if the current block is at or near the vertical picture boundary, wherein M, W and H are positive integers. In yet another embodiment, the current block comprises a w×h subblock at or near the picture boundary and the extended motion-compensated reconstructed block comprises an extended motion-compensated reconstructed w×h subblock, and wherein the extended motion-compensated reconstructed w×h subblock comprises M padded lines beyond a horizontal picture boundary if the w×h subblock is at or near the horizontal picture boundary or beyond a vertical picture boundary if the w×h subblock is at or near the vertical picture boundary, wherein M, w and h arc positive integers.

In one embodiment, a same interpolation filter, associated with a motion compensation process, is used for generating the padded area and an arca inside the reconstructed current block. In one embodiment, a first interpolation filter, associated with a motion compensation process, for generating the padded arca has a shorter number of taps than a second interpolation filter, associated with the motion compensation process, for generating an arca inside the reconstructed current block.

In one embodiment, a same interpolation filter, associated with a motion compensation process, is used for generating all padded samples outside the picture boundary. In one embodiment, said same interpolation filter corresponds to a pre-defined interpolation filter.

In one embodiment, a prediction mode associated with a motion compensation process, for generating padded samples outside the picture boundary is set to a pre-defined value. In one embodiment, the pre-defined value corresponds to LIC, BDOF, BCW, filter type, multi-hypothesis, or inter prediction direction.

In one embodiment, a same prediction mode, associated with a motion compensation process, is used for generating the padded area and an area inside the reconstructed current block. In one embodiment, said same prediction mode corresponds to LIC, BDOF, BCW, filter type, or multi-hypothesis.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of the template area used for estimating the MDBP (Multi-Directional Boundary Padding) angular mode.

FIG. 3 illustrates an example of the two MDBP template areas T₁ and T₂ based on the outermost and the first pixel line respectively, which lay outside of the reference frame.

FIG. 4 illustrates an example of boundary pixel padding using motion compensation according to JVET-K0117.

FIG. 5 illustrates an example of motion-compensated boundary padding method.

FIG. 6 illustrates an example of deriving an M×4 padded block with a left padding direction.

FIG. 7 illustrates an example of padding region in a picture according to an embodiment of the present invention.

FIG. 8 illustrates an example of current picture, reference picture and reference picture's reference picture.

FIG. 9 illustrates a flowchart of an exemplary video coding system that generates padded samples out of the picture boundary during the reconstruction stage according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Multi-Directional Boundary Padding (MDBP)

In JVET-J0014 (M. Albrecht, et al., “Description of SDR, HDR, and 360° video coding technology proposal by Fraunhofer HHI”, Joint Video Experts Team (JVET) of ITU-T SG 16 WP 3 and ISO/IEC JTC 1/SC 29/WG 11, 10th Meeting: San Diego, US, 10-20 Apr. 2018, Document: JVET-J0014), Multi-directional boundary padding (MDBP) is disclosed. Based on the coded block shape, the given motion vector and the number of interpolation filter taps, a particular area of the reference frame is used for motion compensated prediction. In HEVC and JEM (Joint Exploration Model (JEM) for Video Compression), if this referenced sample area is partially or entirely outside the area of the reconstructed reference frame, perpendicular extension of the frame border pixels is used, which may not optimally approximate the predicted block. By exploiting different spatial prediction modes to extend the reference frame border, a better continuation might be achieved. Therefore, multi-directional boundary padding (MDBP) uses angular intra prediction to extend the reference frame border, whenever the referenced pixel area is partially or entirely outside the area of the reconstructed reference frame.

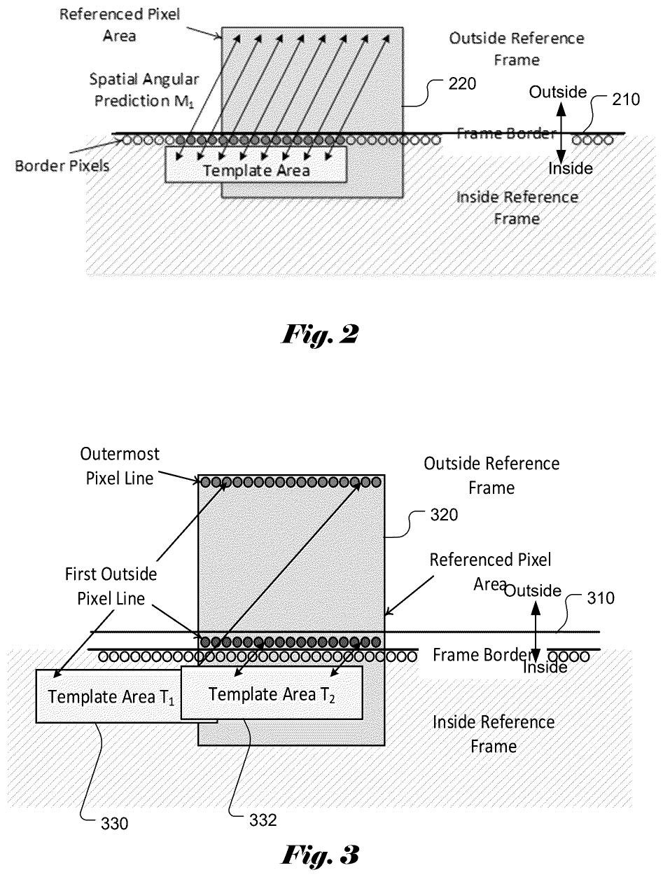

In order to reduce signalling cost for the used angular prediction mode, the best fitting mode is estimated at both the encoder and the decoder side. For the estimation, a template area is defined, which lays inside the reconstructed reference frame as shown in FIG. 2. In FIG. 2, the frame boundary line 210 located on the top side of the frame and a reference area 220 are shown, where the pixels below the frame board line 210 are inside the frame and the pixels above the frame board line 210 are outside the frame.

Furthermore, for every possible angular intra prediction mode, the prediction direction is rotated by 180° to point over the available border pixels inside the reference frame. The template area is then predicted from the adjacent border pixels and is compared with the reconstructed reference frame pixels based on the SAD measure. Finally, the angular prediction mode with the smallest template-based SAD measure is chosen, to predict the referenced pixel area outside the reference frame.

To use the available angular intra prediction for MDBP, some modifications have to be applied. First, for MDBP intra prediction the border pixels are only available at a single side of the predicted area. Therefore, only half of the angular intra prediction modes, such as either horizontal or vertical modes, are used depending on the prediction direction. Second, for the top and left boundaries of the reference frame, the angular intra prediction modes have to be rotated by 180° before applying to MDBP border extension.

FIG. 3 illustrates an example of providing a complete estimate of the entire referenced pixel arca 320 outside the reference frame, and two template areas (330 and 332) being used in JVET-J0014. The first template arca 330 is determined, based on the outermost pixel line parallel to the reference frame border. The second template area 332 is determined, based on the first pixel line outside the reference frame border as shown in FIG. 3, where the frame boundary line 310 is shown.

At the edges of the reference frame, the referenced pixel area overlaps with the frame border at two sides. Here MDBP is only applied at one side (the side, which overlaps with the frame border by most pixels). The remaining side is padded with the perpendicular frame border padding already available.

### Inter/Intra Boundary Padding

In HEVC, reference pictures are extended by a perpendicular padding of the picture boundary samples.

Inter-prediction based boundary padding uses motion compensated prediction to extend the area of the reference picture. The boundary extension area is divided into blocks of 4×M or M×4 samples. Each block is filled by motion compensation using the motion information of the adjacent reference block. For boundary extension blocks without associated motion information and for boundary extension areas for which motion information points to outside of the reference picture, fall-back perpendicular padding is applied. The padding method in JVET-K0363 (Yan Zhang, et al., “CE4.5.2: Motion compensated boundary pixel padding”, Joint Video Experts Team (JVET) of ITU-T SG 16 WP 3 and ISO/IEC JTC 1/SC 29/WG 11, 11th Meeting: Ljubljana, S I, 10-18 Jul. 2018, Document: JVET-K0363) entails addition of an average residual offset to the boundary extension samples, while the padding method in JVET-K0117 (Minsoo Park, et al., “CE4: Results on Reference picture boundary padding in J0025”, Joint Video Experts Team (JVET) of ITU-T SG 16 WP 3 and ISO/IEC JTC 1/SC 29/WG 11, 11th Meeting: Ljubljana, S I, 10-18 Jul. 2018, Document: JVET-K0117) supports bi-prediction of boundary extension samples.

Intra-prediction based boundary padding as proposed in JVET-J0012 (Rickard Sjöberg, et al., “Description of SDR and HDR video coding technology proposal by Ericsson and Nokia”, Joint Video Experts Team (JVET) of ITU-T SG 16 WP 3 and ISO/IEC JTC 1/SC 29/WG 11, 10th Meeting: San Diego, US, 10-20 Apr. 2018, Document: JVET-J0012) uses angular intra-prediction to fill the area of a referenced block outside the reference picture. The applied angular intra-prediction mode is chosen in the encoder and decoder using a probing approach of decoded picture samples.

In JVET-K0195, a harmonized boundary padding approach using inter-prediction and intra-prediction based boundary padding is disclosed and experimental results are reported.

### Inter/Intra-Based Boundary Padding

JVET-K0195 proposes an inter/intra-prediction based boundary padding, that combines per-picture inter-prediction based boundary padding with per-reference intra-prediction based boundary padding. After generation of the inter-prediction based boundary padding, for each reference block entailing boundary padding samples, the number of boundary padding samples originated from perpendicular boundary padding is evaluated. If this number exceeds a threshold (e.g. 50% of boundary padding samples), intra-prediction based boundary padding is used for the reference block instead.

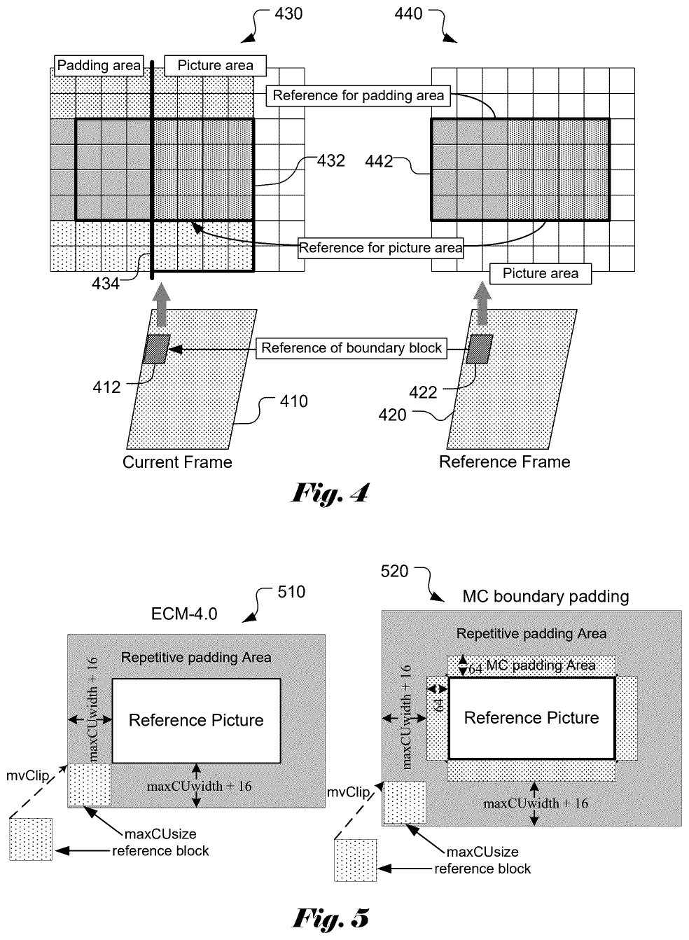

In VVC, outside areas of a reference picture are padded by extrapolating edge pixel of a picture. In JVET-K0117, a padding method for padding outside areas of a picture with motion compensation according to motion information of edge pixel of the picture is disclosed as shown in FIG. 4. In FIG. 4, boundary block 412 in the current frame 410 is shown and details of the padding 430 around this boundary block is illustrated. The corresponding boundary block 422 in the reference picture 420 is shown in the lower right of FIG. 4 and the details 440 of the corresponding boundary block is shown in the upper right of FIG. 4. In the details 430 of the padding around this boundary block, the boundary line 434 is shown. The pixels on the left side of the boundary line of reference arca 432 are not available and need to be padded. The corresponding reference arca 442 is located and is used to derive reference arca 432 as indicated by the arrows in FIG. 4.

To use the motion information of the edge pixels, each 4×4 block is checked at the boundary of the picture. If there is motion information in the block, the location of the block is checked in the reference picture of the block. If the location is located in the image area, check whether the neighbouring area of the reference area is available.

The location of the neighbouring area may be located in four directions, up, down, left, right. The orientation of the adjacent area is the same as the location of the padding area. For example, if the padding area is located on the left side of the picture, then the inspection area is also on the left side of the pixel. The “inspection area” here means the reference samples lies around the reference blocks. For example, if left picture boundary padding is going to be performed, reference samples at left-hand side of reference block are checked. In addition, the length of the side that does not face the picture of the padding area is determined by the distance between the position of the pixel of the reference picture and the position of the edge pixel or by the size of the padding arca. The shorter of them is selected. If the predetermined length is shorter than the size of the padding area, the rest of the area is filled with extrapolated edge pixels of the external picture.

The available adjacent area is derived by motion compensation. However, a conventional padding method is performed when an adjacent area is unavailable or there is no information about the motion in a boundary block. The block can have two pieces of information about movement. In this case, each information is used to create a padding image and integrate two images into one. In addition, the last pixel of each position is extrapolated to induce a left upper portion, a right upper portion, a left lower portion, and a right padding arca.

### Motion Compensated Boundary Pixel Padding

In JVET-K0363, motion compensated boundary pixel padding is disclosed. When motion compensation is performed in the decoder side, it is possible that the motion vector points to a reference block that is partially or entirely located outside the reference slice. Without boundary padding, these pixels will be unavailable. Traditionally, the reference slice is padded using repetitive padding method which repeats the outer most pixel in each of the four directions for a certain amount of times depending on the padding size. These padded pixels can only provide very limited information since it is very likely that the padded arca does not contain any meaningful content comparing to those that lie inside the boundary.

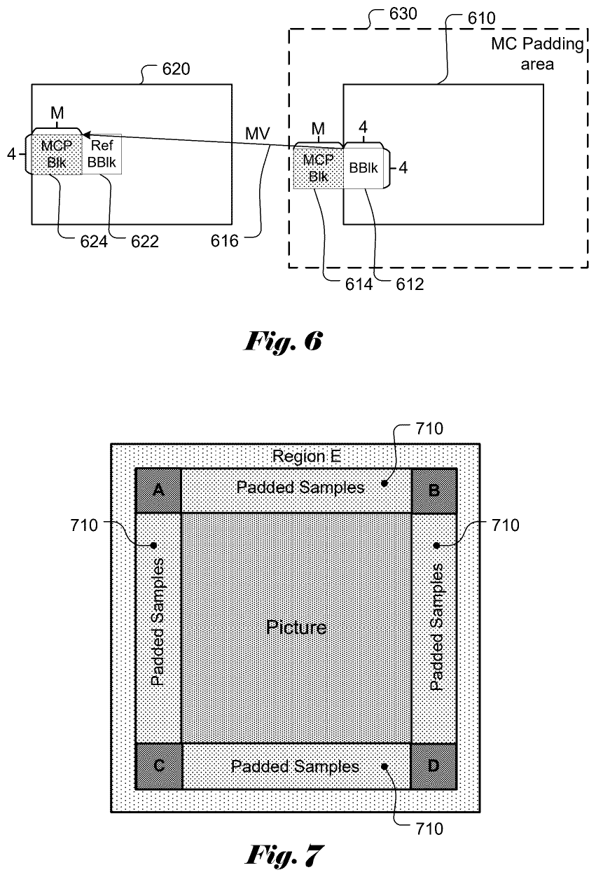

In JVET-K0363, a new boundary pixel padding method is introduced so that more information can be provided by the padded areas in the reference slice. A motion vector is first derived from the boundary 4×4 block inside the current frame as shown in FIG. 5, where the padding is shown on the left (510) and the MC padding according to JVET-K0363 is shown on the right (520). If the boundary 4×4 block is intra coded or the motion vector is not available, repetitive padding will be used. If the boundary 4×4 block is predicted using uni-directional inter prediction, the only motion vector within the block will be used for motion compensated boundary pixel padding. Using the position of the boundary 4×4 block and its motion vector, a corresponding starting position can be computed in the reference frame. From this starting position till the boundary of the reference slice in the given padding direction, a 4×M or M×4 image data can be fetched where M is the distance between the horizontal/vertical coordinate of the boundary pixel position and the starting position depending on the padding direction. Here in the CE test, M is forced to be smaller than 64. In case of bi-directional inter prediction, only the motion vector, which points to the pixel position farther away from the frame boundary in the reference slice in terms of the padding direction, is used in motion compensated boundary pixel padding. The difference between the DC values of the boundary 4×4 block in the current slice and its corresponding reference 4×4 block in the reference slice is used as the offset to filter the fetched motion compensated image data before it is copied to the padding area beyond the image boundary.

In ECM-5.0, bi-prediction is performed in a way that avoids relying on reference samples out of a reference picture bounds (OOB), if possible.

To do so, in the case of a bi-predicted block with an OOB reference block in one of the two reference pictures, the OOB prediction samples are not used. The concerned part of the block is rather uni-predicted based on non-OOB prediction samples, if available in the other reference picture.

However, for a uni-predicted block with an OOB reference block or for a bi-directional predicted block with both OOB reference samples, repetitive padded pixels are used instead of MC.

That is, in ECM-5.0, pictures are extended by an area surrounding the picture with a size of (maxCUwidth+16) in each direction of the picture boundary. The pixel in the extended area is derived by repetitive boundary padding. When a reference block used for uni-prediction is located partially or completely out of the picture boundary (OOB), the repetitive padded pixel is used instead of motion compensation (MC).

In JVET-Z0130 (Zhi Zhang, et al., “EE2-related: Motion compensation boundary padding”, Joint Video Experts Team (JVET) of ITU-T SG 16 WP 3 and ISO/IEC JTC 1/SC 29/WG 11, 26th Meeting, by teleconference, 20-29 Apr. 2022, Document: JVET-Z0130), a method called motion compensated boundary padding replaces the repetitive boundary padding, for increased coding efficiency.

In JVET-AA0096 (Fabrice Le Léannec, et al., “EE2-2.2: Motion compensated picture boundary padding”, Joint Video Experts Team (JVET) of ITU-T SG 16 WP 3 and ISO/IEC JTC 1/SC 29/WG 11, 27th Meeting, by teleconference, 13-22 Jul. 2022, Document: JVET-AA0096), samples outside of the picture boundary are derived by motion compensation instead of using only repetitive padding as in ECM. In the implementation, the total padded area size is increased by 64 (test 2.2a) or 16 (test 2.2b) compared to ECM (Enhanced Compression Model). This is to keep MV clipping, which implements repetitive padding, non-normative.

For motion compensated padding, MV of a 4×4 boundary block is utilized to derive an M×4 or 4×M padded block. The value M is derived as the distance of the reference block to the picture boundary as shown in FIG. 6, where MC padding areas 630 are added to the current picture 610 and reference picture 620 is shown. For a 4×4 boundary block 612, the corresponding reference block 622 is located according to a motion vector 616. The M×4 padded block 614 for the current picture and the M×4 padded block 624 for the reference picture are shown. Moreover, M is set at least equal to 4 as soon as the motion vector points to a position internal to the reference picture bounds. If the boundary block is intra coded, then MV is not available, and M is set equal to 0. If M is less than 64, the rest of the padded area is filled with the repetitive padded samples.

In case of bi-directional inter prediction, only one prediction direction, which has a motion vector pointing to the pixel position farther away from the picture boundary in the reference picture in terms of the padding direction, is used in MC boundary padding.

The pixels in MC padded block are corrected with an offset, which is equal to the difference between the DC values of the reconstructed boundary block and its corresponding reference block.

In order to further improve the coding performance, new padding method is proposed for picture boundary padding. Unlike repetitive padding in HEVC and VVC, intra-prediction-based, inter-prediction-based or the combination of both and repetitive padding are allowed in picture boundary padding according to the present invention. For intra-prediction-based padding method, conventional intra-prediction method can be utilized to generate the boundary padded samples, or implicit method at both the encoder and decoder-side derivation method or other signalling methods can also be performed. The intra-prediction-based padding method is applied before the loop filtering (for example, in CU reconstruction stage). For inter-prediction-based padding method, instead of performing motion compensation after loop filtering, during encoding and decoding, larger motion-compensated blocks including padded samples are generated. Further operations may also be invoked during motion compensation. Besides, the reference pictures of reference pictures of current pictures may also be used during padded samples generation.

In one embodiment, padded samples are derived based on a certain intra-prediction mode, such as planar mode. In order to generate such padded samples, two sides of reference samples may be required, but one side of them may be unavailable. Reference samples padding may also be applied to reference samples, and intra-prediction is performed to derive padded samples.

In one embodiment, if the current block within the picture is an intra mode coded block, the same intra mode can be used (for example, the same intra angular mode) to generate the padded results for the sample outside of picture boundary. The reference samples of the intra prediction for the block outside the boundary can be the reconstructed current sample, or the reference sample of the intra prediction of the current block. In one example, the chroma intra prediction can also be applied in the similar way of luma block does.

In one embodiment, if the current block uses the intra template matching prediction (Intra-TMP), intra block copy (IBC) or intra block copy with template matching (IBC-TM), the intra block copy can also be applied to the out of boundary block (OOB block). For example, the block vector (BV) of the current block is used to generate the predictors as the padded samples of the OOB block.

In another embodiment, template-based intra mode derivation (TIMD) is performed to derive padded samples. Unlike using two template regions determined by certain outside pixel lines in JVET-J0014, a region of template is used and SAD is calculated between predicted padded samples and template region. Blending processing for the predicted padded samples may also be performed.

In another embodiment, decoder-side intra mode derivation (DIMD) is performed to derive padded samples. To generate padded samples, firstly Sobel filters are utilized to compute histogram data based on current reconstruction samples. Prediction mode indices are determined according to histogram data and final predicted padded samples are generated from the selected prediction mode index using reconstruction samples. In one example, the boundary samples of the current block are used to derive the intra prediction mode by DIMD. The reconstructed samples of the current block can be used as the reference samples to generate the padded samples of the OOB block.

In another embodiment, between the padded samples and reconstruction samples, position dependent intra-prediction combination (PDPC) may be applied to solve the discontinuity. The process of PDPC may be applied just like that in VVC, or applied differently with fewer lines or more lines, weaker weightings or stronger weightings at padded samples.

In another embodiment, during encoding and decoding, for those blocks at picture boundaries, larger motion compensated blocks are generated, such as (M+4)×4 blocks or 4×(M+4) blocks, where M is the length of padded samples. In another example, the padding sample can be generated with the whole CU, as the (M+H)×W block or W×(M+H) block, where M is the length of padded samples, W and H are the block width and height. In another example, the padding sample can be generated with the subblock of the current block, as the (M+h)×w blocks or w×(M+h) blocks, where M is the length of padded samples, w and h are the subblock width and height. The subblock size can be predefined, or be different values for different modes.

In one embodiment, when doing motion compensation, a check is performed to see whether the current block/current subblock is in the picture boundary. If yes, the additional reference samples (e.g. reference sample for (M+h)×w blocks or w×(M+h) blocks) are loaded. The OOB block samples are generated at the sample stage of current block/current subblock reconstruction.

In another embodiment, during motion compensation for padded samples, the same interpolation filter is used for both padded samples and blocks inside the picture. Another embodiment is that interpolation filter is the same for all padded samples outside the picture (e.g. a predefined filter is used for the padded samples).

In one embodiment, during motion compensation, the prediction mode used for the OOB block is set to a predefined value. The prediction mode can be LIC, BDOF, BCW, filter type, multi-hypothesis, inter prediction direction, etc.

In another embodiment, during motion compensation, the prediction mode used for blocks inside the picture is also applied to the OOB block. The prediction mode can be LIC, BDOF, BCW, filter type, multi-hypothesis, etc.

In another embodiment, during motion compensation, local illumination compensation (LIC) for padded samples is applied if LIC is also applied to blocks inside the picture. Another embodiment is that bi-directional optical flow (BDOF) for padded samples is applied if BDOF is also applied to blocks inside the picture.

In one embodiment, shorter filter-tap interpolation can be used for OOB sample MC. For example, the integer MC, or 2-tap, or 4-tap, or 6-tap, or 8-tap filter is used for OOB sample MC. The MV for OOB block MC can also be rounded to coarser granularity.

In another embodiment, the OOB samples can only be generated by using the same reference samples (for MC process or for decoder side mode/MV derivation) of the current block/current sub-block inside the picture boundary. No additional reference sample can be allowed.

In another embodiment, the OOB samples can only be generated by using the same reference samples (for MC process or for decoder side mode/MV derivation) plus a small predefined or adaptive amount of samples of the current block/current sub-block inside the picture boundary.

In another embodiment, after generation of padded samples, further offset or compensation is applied to padded samples. One method is to calculate the difference between the whole boundary blocks of the picture and the whole generated padded samples to derive the offset. Another method is to calculate the difference between the boundary blocks at one side of the boundary and the generated padded samples at the other side of the boundary to derive the offset.

In another embodiment, for corner pixels (A, B, C and D) as shown in FIG. 7, padded samples can be generated according to different methods. For example, padded samples at A, B, C, and D can be generated according to left-top corner samples of the picture, right-top corner samples of the picture, left-bottom corner samples of the picture, and right-bottom corner samples of the picture respectively. Another example is that after padded samples in the FIG. 7 are generated, padded samples at A, B, C, D are generated according to weighted sum of corresponding neighbouring padded samples (i.e., two rectangular grey padded samples regions 710). Another example is that after padded samples in FIG. 7 are generated, padded samples in A, B, C, D are generated directly from neighbouring padded samples (e.g., region A are generated from its right neighbouring padded samples).

In another embodiment, after padded samples are generated, further padding operation is applied to make padded frame in a rectangular size, as shown in region E in FIG. 7. The further padding operation may generate padded samples in region E according to different methods. An example is that padded samples in region E are generated directly from the boundary of picture or from padded samples in FIG. 7.

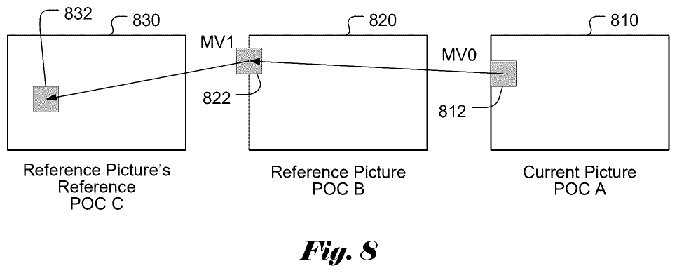

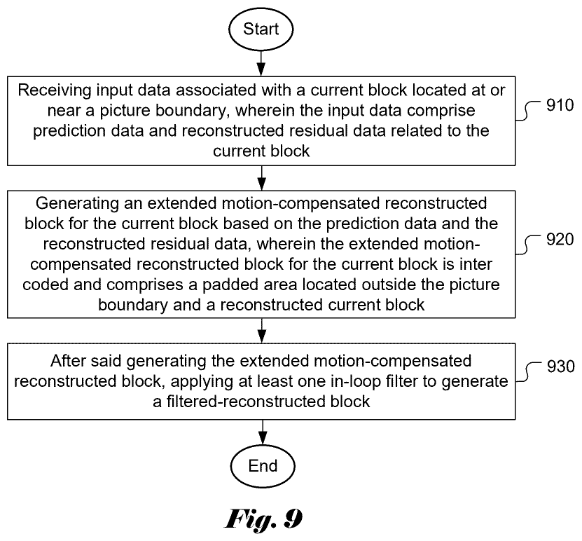

In another embodiment, when using the boundary blocks to do motion compensation, it is possible that the reference block on the reference picture is partially outside the picture, as shown in FIG. 8. In this case, it can use the reference block in reference picture's reference if the reference block in the reference picture is inter-coded. In one example, only the part outside the picture uses the reference block in reference picture's reference. In another example, when the reference block in reference picture exceeds the picture boundary, the reference block in reference picture's reference is used to generate padded samples.

In another embodiment, as shown in FIG. 8, there are possible two MVs (MV0 and MV1) in three pictures, where picture 810 corresponds to a current picture, picture 820 corresponds to the reference picture and picture 830 corresponds to the reference picture of the reference picture. Block 812 corresponds to boundary block in the current picture. Motion vector MVO associated with block 812 points to reference block 822 (part of the reference block is outside the reference picture) in the reference picture 820. Motion vector MVI associated with reference block 822 points to another reference block 832 in the reference picture 830 of the reference picture 820. During padded samples generation, another reference block may be considered. In one example, we add two MVs (e.g. MV0 and MV1) together to get another reference block in another reference picture or reference picture's reference. In another example, we average two MVs to get another reference block in reference picture or reference picture's reference.

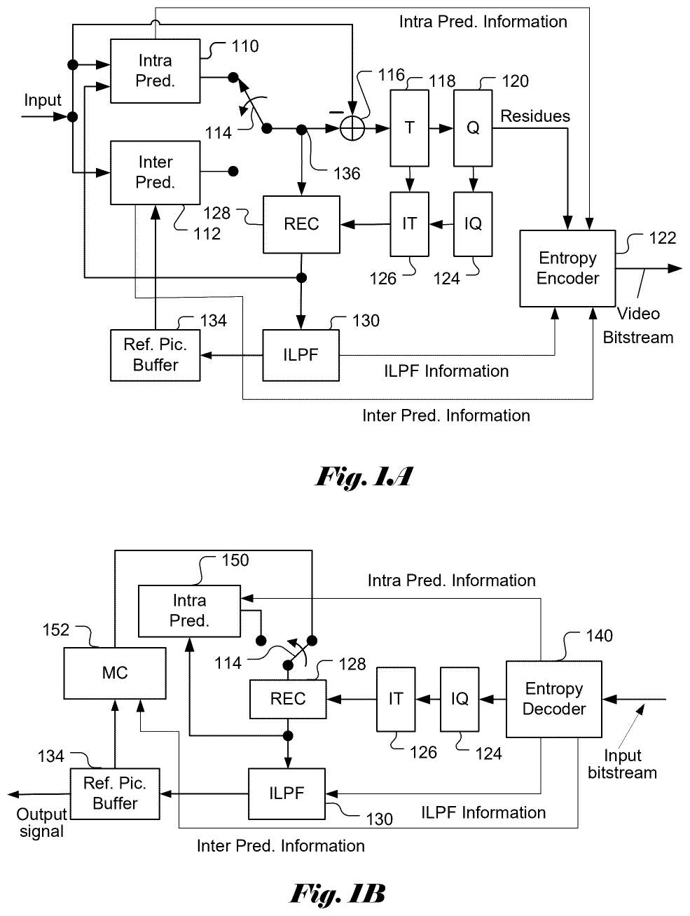

Any of the foregoing proposed sample padding methods for out-of-boundary pixels can be implemented in encoders and/or decoders. For example, any of the proposed sample padding methods can be implemented in predictor derivation module (e.g. Inter pred. 112 and/or Intra Pred. 110 in FIG. 1A) and reconstruction stage (e.g. REC 128 in FIG. 1A) of an encoder, and/or a predictor derivation module (e.g. MC 152 and/or Intra Pred. 150 in FIG. 1B) and reconstruction stage (e.g. REC 128 in FIG. 1A) of a decoder. Alternatively, any of the proposed methods can be implemented as a circuit coupled to the predictor derivation module and reconstruction stage of the encoder and/or the predictor derivation module and reconstruction stage of the decoder, so as to provide the information needed by the predictor derivation module. The padding methods may also be implemented using executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 9 illustrates a flowchart of an exemplary video coding system that generates padded samples out of the picture boundary during the reconstruction stage according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block located at or near a picture boundary are received in step 910, wherein the input data comprise prediction data and reconstructed residual data related to the current block. An extended motion-compensated reconstructed block for the current block is generated based on the prediction data and the reconstructed residual data in step 920, wherein the extended motion-compensated reconstructed block for the current block is inter coded and comprises a padded area located outside the picture boundary and a reconstructed current block. At least one in-loop filter is applied to the extended motion-compensated reconstructed block in step 930.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block located at or near a picture boundary, wherein the input data comprise prediction data and reconstructed residual data related to the current block;
generating an extended motion-compensated reconstructed block for the current block based on the prediction data and the reconstructed residual data, wherein the extended motion-compensated reconstructed block for the current block is inter coded and comprises a padded area located outside the picture boundary and a reconstructed current block;
after said generating the extended motion-compensated reconstructed block, applying at least one in-loop filter to generate a filtered-reconstructed block.

2. The method of claim 1, wherein the current block corresponds to a 4×4 block at or near the picture boundary and the extended motion-compensated reconstructed block comprises M padded lines beyond the picture boundary, wherein M is a positive integer.

3. The method of claim 1, wherein the current block corresponds to a W×H block at or near the picture boundary and the extended motion-compensated reconstructed block comprises M padded lines beyond a horizontal picture boundary if the current block is at or near the horizontal picture boundary or beyond a vertical picture boundary if the current block is at or near the vertical picture boundary, wherein M, W and H are positive integers.

4. The method of claim 1, wherein the current block comprises a w×h subblock at or near the picture boundary and the extended motion-compensated reconstructed block comprises an extended motion-compensated reconstructed w×h subblock, and wherein the extended motion-compensated reconstructed w×h subblock comprises M padded lines beyond a horizontal picture boundary if the w×h subblock is at or near the horizontal picture boundary or beyond a vertical picture boundary if the w×h subblock is at or near the vertical picture boundary, wherein M, w and h are positive integers.

5. The method of claim 1, wherein a same interpolation filter, associated with a motion compensation process, is used for generating the padded area and an area inside the reconstructed current block.

6. The method of claim 1, wherein a first interpolation filter, associated with a motion compensation process, for generating the padded area has a shorter number of taps than a second interpolation filter, associated with the motion compensation process, for generating an area inside the reconstructed current block.

7. The method of claim 1, wherein a same interpolation filter, associated with a motion compensation process, is used for generating all padded samples outside the picture boundary.

8. The method of claim 7, wherein said same interpolation filter corresponds to a pre-defined interpolation filter.

9. The method of claim 1, wherein a prediction mode associated with a motion compensation process, for generating padded samples outside the picture boundary is set to a pre-defined value.

10. The method of claim 9, wherein the pre-defined value corresponds to LIC, BDOF, BCW, filter type, multi-hypothesis, or inter prediction direction.

11. The method of claim 1, wherein a same prediction mode, associated with a motion compensation process, is used for generating the padded area and an area inside the reconstructed current block.

12. The method of claim 11, wherein said same prediction mode corresponds to LIC, BDOF, BCW, filter type, or multi-hypothesis.

13. An apparatus for video coding, the apparatus comprising one or more electronics or processors arranged to:
receive input data associated with a current block located at or near a picture boundary, wherein the input data comprise prediction data and reconstructed residual data related to the current block;
generate an extended motion-compensated reconstructed block for the current block based on the prediction data and the reconstructed residual data, wherein the extended motion-compensated reconstructed block for the current block is inter coded and comprises a padded area located outside the picture boundary and a reconstructed current block;
after extended motion-compensated reconstructed block is generated, apply at least one in-loop filter to generate a filtered-reconstructed block.
